(19) United States
(12) Patent Application Publication
(10) Pub. No.: US 2008/0313826 A1
(43) Pub. Date: Dec. 25, 2008

(54) STATIONARY DOCK LEVELER

(76) Inventors: Hans Josef Kloppenburg, Volkmarsen (DE); Norbert Hahn, Franklin, WI (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/765,939

(22) Filed: Jun. 20, 2007

(51) Int. Cl. B65G 69/28; A47B 3/083

(52) U.S. Cl. 14/71.1; 108/171

(57) ABSTRACT

The subject matter of the invention is a stationary dock leveler with a ramp (10, 20) and with a dock leveler (12, 22) that is tiltably held, over a horizontally oriented pivot joint (14, 24), to the ramp (10, 20), whereby the dock leveler (12, 22) contains a dock leveler top plate (13, 23) constructed as a surface that can be driven over, and whereby a ramp plate (11, 21), constructed as a surface that can be driven over, is provided on the ramp (10, 20). Providing a device that reduces the impact on the vehicle that traverses it to a minimum, and that can be manufactured economically, achieved by that a ramp plate (11, 21) extending up to over the pivot joint (14, 24) and a dock leveler top plate (13, 23) also extending up to over the pivot joint (14, 24), so that a gap (15, 25) formed between the ramp plate (11, 21) and the dock leveler top plate (13, 23) is arranged over the center of the pivot joint (14, 24).

### FIELD OF THE DISCLOSURE

The present disclosure relates generally to a stationary dock leveler.

### BACKGROUND

Stationary dock levelers are typically used with vehicles, in general fork lift trucks, to transport goods to the truck that waits at the loading dock. The dock leveler acts as a bridge that can be adjusted in height so that this vehicle can get onto the cargo area of the truck in an easy manner.

However, this gives rise to the possibility that, at the transition between the actual loading dock or ramp and the dock leveler, a gap and, if applicable, a projecting edge can occur, that exert an unpleasant impact on the vehicle and its driver. In order to protect the health of the driver and diminish the stress on the vehicle it is now strived for to design this gap and this edge in such a way that the occurring impact is reduced to a minimum.

In EP 1 544 139 A1 it was proposed to solve this problem by providing between the actual ramp and the movable dock leveler an additional, in this case a circularly shaped, metal sheet that at least partially closes the gap and creates in this way a smooth transition. In another embodiment of the dock leveler according to EP 1 544 139 A1 the metal sheet is integrally constructed on the dock leveler and the side that is facing the ramp is turned down at an angle of 90°. The gap that remains in this case changes its size with the position of the dock leveler so that during the traversal of the gap in many situations still an unpleasant impact is exerted on the driver of the vehicle. In addition, such a construction is relatively expensive to manufacture.

Starting from this, the present disclosure is based on the task to create a dock leveler of the type mentioned in the introduction with which the impact exerted on the crossing vehicle is reduced to a minimum and that can be manufactured in an economical way.

### SUMMARY

A dock leveler that is constructed according to this technical method has the advantage that, due to the arrangement of the gap over the center of the pivot joint, it is achieved at the same time that neither the ramp plate nor the dock leveler top plate extends over the center of the pivot joint. At the same time, the ramp plate as well as the dock leveler top plate end either precisely in a vertical, and through the pivot axis extending, plane or in the neighborhood of this plane, so that the end of the dock leveler top plate only travels a minimal vertical distance during the tilting of the dock leveler. In this way the gap only changes minimally and at the same time this is achieved very economically since no additional components or other complicated constructions are required.

### BRIEF DESCRIPTION OF THE DRAWINGS

Additional advantages of the dock leveler according to the invention will become clear from the included drawings and descriptions of the following the embodiments. Likewise, the in the above mentioned, and in addition implemented features according to the invention, can be used individually or in arbitrary combinations with each other. The mentioned embodiments are not to be understood as a complete account of the possible variations, but are more along the lines the nature of examples.

FIGS. 1a-1c illustrate a side view cross section depiction of a first embodiment of a dock leveler according to the invention in different positions.

FIGS. 2a-2c illustrate a side view cross section depiction of a second embodiment of a dock leveler according to the invention in different positions.

### DETAILED DESCRIPTION

The following description of the disclosed embodiment is not intended to limit the scope of the invention to the precise form or forms detailed herein. Instead the following description is intended to be illustrative of the principles of the invention so that others may follow its teachings.

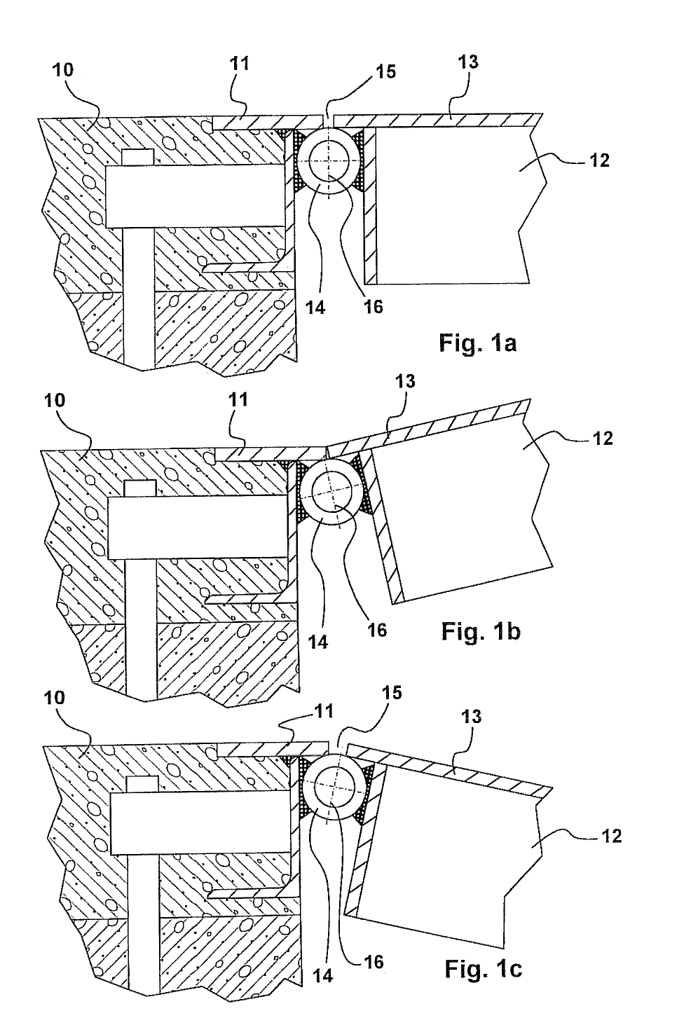

FIGS. 1a to 1c depict a first embodiment of a stationary dock leveler according to the invention that includes a ramp 10 and a ramp plate 11 attached at the top side of the ramp at the edge of the ramp 10, and a dock leveler 12 and a (dock leveler) top plate 13 attached to the top side of the dock leveler 12. The dock leveler 12 is thereby tiltably held to the ramp 10 by means of a pivot joint 14.

In FIG. 1a the ramp plate 11 is arranged in the immediate proximity of the top plate 13, separated by a gap 15. The ramp plate 11 and the top plate 13 thereby extend over the pivot joint 14 so that the gap 15 is centered over the swivel axis of the pivot joint 14.

In FIG. 1b the dock leveler 12 is rotated about 12.5° upwards. The gap 15 is thereby reduced to a minimum, whereby now, because of the arrangement of the ramp plate 11 and the top plate 13, both are in contact with each other, so that the gap 15 is bridged. In this state the vehicle that traverses the dock leveler can drive without impact on the dock leveler.

In FIG. 1c the dock leveler 12 is rotated about 12.5° downwards. The gap 15 is enlarged to a maximum due to this. Because of the arrangement of the ramp plate 11 up to over the pivot joint 14 and the construction of the top plate 13 up to over the pivot joint 14, it is achieved that the gap 15 does not become excessively large, even when it reaches its maximum size. Even though the vehicle and its driver experience a certain impact due to the gap 15 when the vehicle now traverses the dock leveler, it is, however, minimized to such an extent that negative effects on the driver or a wear of the vehicle are not expected.

In the first embodiment, depicted in FIGS. 1a to 1c, the gap 15 is arranged in such a way that it lies up to the center of the pivot joint 14. That is, a virtual centerline of the gap 15 lies in the same plane as a swivel axis 16 of the pivot joint 14.

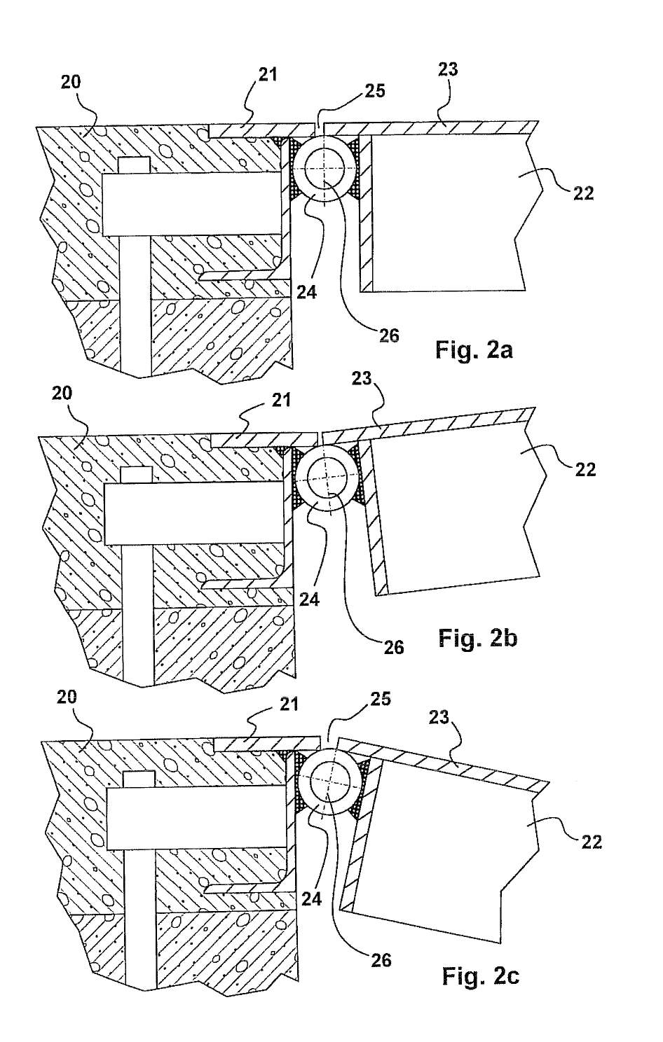

The in FIGS. 2a to 2c depicted second embodiment of a stationary dock leveler according to the invention merely differs from the, in FIGS. 1a to 1c depicted, first embodiment in that in FIG. 2a the gap 25, formed by the ramp plate 21 and the dock leveler top plate 23, now no longer lies centered over the pivot joint 24, but that the top plate 23 lies with its outer edge over the swivel axis 26 of the pivot joint 24, so that the gap 25 is located beside the swivel axis 26.

As can be seen from FIGS. 2b and 2c, the gap 25 is reduced to a minimum upon tilting the dock leveler 22 upwards and increased to a maximum upon tilting the dock leveler 22 downwards. Nevertheless, also in this extreme positions the gap 25 remains so small that the resulting impact on the vehicle and its driver that traverses it remains at a minimum.

It is to be understood that in another, here not represented embodiment, the gap can be arranged differently over the pivot joint as long as the gap is arranged over the swivel axis of the pivot joint and as long as either the outer edge of the ramp plate or the outer edge of the dock leveler top plate lies over the swivel axis of the pivot joint.

For conventional stationary dock levelers it has been established that the gap must have a width between 8 mm and 15 mm, preferably 11 mm, so that the swivel motion of the dock leveler can be realized. The gap can have different sizes for other dock levelers.

In another, here not represented embodiment, the edge of the ramp plate and/or the dock leveler top plate that is turned towards the gap is beveled in order to make the traversing of the gap even smoother.

Although the teachings of the invention have been illustrated in connection with certain embodiments, there is no intent to limit the invention to such embodiments. On the contrary, the intention of this application is to cover all modifications and embodiments fairly falling within the scope of the appended claims either literally or under the doctrine of equivalents.

We claim:

1. A dock leveler with a ramp (10, 20) and with a dock leveler (12, 22) that is tiltably held, over a horizontally oriented pivot joint (14, 24), to the ramp (10, 20), whereby the dock leveler (12, 22) contains a dock leveler top plate (13, 23), constructed as a surface that can be driven over, and whereby a ramp plate (11, 21), constructed as a surface that can be driven over, is provided on the ramp (10, 20), characterized by
that the ramp plate (11, 21) extends up to over the pivot joint (14, 24) and that the dock leveler plate (13, 23) also extends up to over the pivot joint (14, 24), so that a gap (15, 25) constructed between the ramp plate (11, 21) and the dock leveler top plate (13, 23) is arranged over the vertical centerline (16) of the pivot joint (14, 24).

2. A dock leveler according to claim 1, characterized by
that the gap (15, 25) has a width between 8 mm and 15 mm, preferably 11 mm.

3. A dock leveler according to claim 1, characterized by
that the gap (15, 25) is arranged left adjusted, centered, or right adjusted, over the vertical centerline (16) of the pivot joint (14, 24).

4. A dock leveler according to claim 3, characterized by
that the gap (15, 25) has a width between 8 mm and 15 mm, preferably 11 mm.
